(19) United States
(12) Patent Application Publication
(10) Pub. No.: US 2025/0225484 A1
(43) Pub. Date: Jul. 10, 2025

(54) METHOD OF AUTOMATING COLLECTION AND SCREENING OF RESUMES

(71) Applicant: FUSEMACHINES, INC., New York, NY (US)

(72) Inventors: Shushanta Pudasaini, Kathmandu (NP); Sunil Ghimire, Kathmandu (NP); Bijaya Khadka, Kathmandu (NP); Mahendra Singh Thapa, Kathmandu (NP); Giovanni Patrick Lemus, New York, NY (US); Rakesh Kumar Katuwal, Kathmandu (NP); Sameer Maskey, New York, NY (US)

(21) Appl. No.: 18/732,261

(22) Filed: Jun. 3, 2024

Related U.S. Application Data
(60) Provisional application No. 63/470,336, filed on Jun. 1, 2023.

(51) Int. Cl. G06Q 10/1053; G06F 16/35; G06F 40/279

(52) U.S. Cl. CPC G06Q 10/1053; G06F 16/35; G06F 40/279

(57) ABSTRACT

The present disclosure provides a method of automating the collection and screening of resumes in which a user inputs a job description in a job input module and selects potential candidates through a resume input module and the job parsing module may extract the keywords from the job description and a resume parsing module determines keywords from the candidates resumes and a scoring module that provides a score which indicates how closely matched a resume is to the job description.

### CROSS-REFERENCE TO RELATED APPLICATIONS

The present patent application claims the priority benefit of U.S. provisional patent application 63/470,336 filed Jun. 1, 2023 the disclosure of which is, incorporated herein by reference.

### BACKGROUND OF THE DISCLOSURE

### 1. Field of the Disclosure

The present disclosure is generally related to automating resume collection and screening.

### 2. Description of the Related Art

Currently, there are many issues with collecting resumes including bias from hiring managers, a lack of standardization with the resumes making it difficult to compare candidates, resumes that have incomplete information, or resumes that contain fraudulent or inaccurate information. Also, there is a challenge with screening resumes including the hiring managers unconsciously bringing in stereotypes to the screening process, resumes that include misleading information, and recruiters having limited time constraints and resources to review resumes thoroughly. Lastly, currently automation tools for the hiring process may lack transparency by using complex algorithms that are hard or difficult to understand, may not have the ability to understand the context or nuances of a resume including a candidate's qualifications or experience, and generating false positives or negatives which leads to an ineffective recruiting process. Thus, there is a need in the prior art to provide a method to effectively automating collection and screening of resumes.

### SUMMARY OF THE CLAIMED INVENTION

The present disclosure provides a method of automating the collection and screening of resumes in which a user inputs a job description in a job input module and selects potential candidates through a resume input module and the job parsing module may extract the keywords from the job description and a resume parsing module determines keywords from the candidates resumes and a scoring module that provides a score which indicates how closely matched a resume is to the job description.

### BRIEF DESCRIPTIONS OF THE DRAWINGS

FIG. 1 illustrates an example system for performing a method of automating the collection and screening of resumes.

FIG. 2 illustrates an example workflow performed by a managing module, including steps performed by a job input module, a resume input module, and a job parsing module.

FIG. 3 illustrates an example workflow performed by a resume parsing module.

FIG. 4 illustrates an example workflow performed by a scoring module.

FIG. 5 illustrates an example of computing system.

FIG. 6 illustrates an example neural network architecture.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

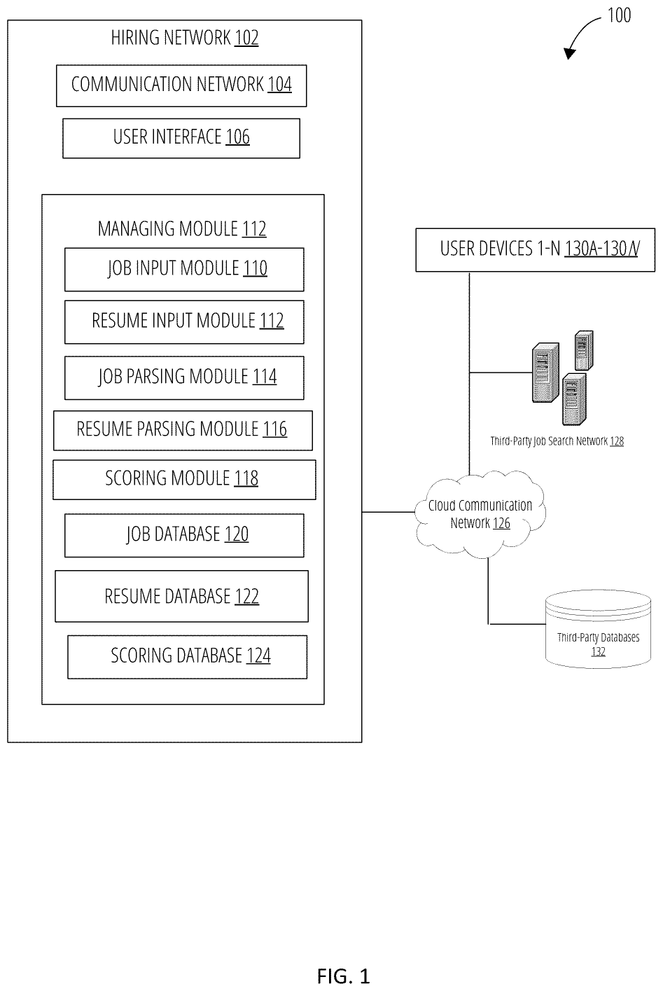

FIG. 1 illustrates an example system for performing a method for automating the collection and screening of resumes.

The system may comprise a hiring network 102 which may be a platform that provides user's the ability to create a job description and upload resumes and/or cover letters that are stored locally on the user's device or through connecting to 3rd party job search networks 128. In some embodiments, the hiring network 102 may be capable of sourcing talent, screening and matching job candidates to job positions, manage contracts, payroll, taxes, etc. as well as manage employees experience. In some cases, the hiring network 102 may include a communication network 104 which may be a wired and/or a wireless network. The communication network 104, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network 104 may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

In some cases, the hiring network 102 may include a user interface(s) 106 which may either accept inputs from users or provide outputs to the users or may perform both the actions. In one case, a user can interact with the user interface(s) 106 using one or more user-interactive objects and devices. The user-interactive objects and devices may comprise user input buttons, switches, knobs, levers, keys, trackballs, touchpads, cameras, microphones, motion sensors, heat sensors, inertial sensors, touch sensors, or a combination of the above. Further, the user interface(s) 106 may either be implemented as a Command Line Interface (CLI), a Graphical User Interface (GUI), a voice interface, or a web-based user-interface.

In some cases, the hiring network 102 may include a managing module 108 which initiates the job input module 110 that allows users of the hiring network 102 to input and store a job description, a resume input module 112 that allows users to select and upload candidates resumes to the hiring network 102, a job parsing module 114 which determines the keywords in the job description, a resume parsing module 116 which may extract the information from the resume including the keywords mentioned, and a scoring module 118 which compares the keywords from the job description and the resume to determine a numeric value which represents how closely matched the resume is to the job description.

In some cases, the hiring network 102 may include a job input module 110 which may begin by being initiated by the managing module 108. The user inputs the job description for the job into the user interface 106. The user submits the job description for the job through the user interface 106. The job input module 110 stores the job description in the job database 120. The job input module 110 returns to the managing module 108. In some cases, the hiring network 102 may include a resume input module 112 which may begin by being initiated by the managing module 108. The resume input module 112 connects to the 3rd party job search network 128. The user selects the resumes through the connection to the 3rd party job search network 128. The resume input module 112 stores the selected resumes in the resume database 122. The resume input module 112 returns to the managing module 108.

In some cases, the hiring network 102 may include a job parsing module 114 which may begin by being initiated by the managing module 108. The job parsing module 114 may extract the job description from the job database 120. The job parsing module 114 may extract the textual information from the job description. The job parsing module 114 may extract the keywords from the job description. The job parsing module 114 stores the data in the job database 120. The job parsing module 114 returns to the managing module 108.

In some cases, the hiring network 102 may include a resume parsing module 116 which may begin by being initiated by the managing module 108. The resume parsing module 116 may extract the first resume from the resume database 122. The resume parsing module 116 may extract the textual information from the resume. The resume parsing module 116 identifies the language the resume is written in. The resume parsing module 116 determines if the resume is written in English. If it is determined that the resume is not written in English the resume parsing module 116 translates the resume to English. If it is determined that the resume is written in English or after the resume is translated to English the resume parsing module 116 performs segmentation on the resume. The resume parsing module 116 may extract the keywords from the resume. The resume parsing module 116 stores the data in the resume database 122. The resume parsing module 116 determines if there are more resumes remaining in the resume database 122. If it is determined that there are more resumes remaining in the resume database 122 the resume parsing module 116 may extract the next resume from the resume database 122 and the process returns to extracting the textual information from the resume. If it is determined that there are no more resumes remaining in the resume database 122 the resume parsing module 116 returns to the managing module 108.

In some cases, the hiring network 102 may include a scoring module 118 which may begin by being initiated by the managing module 108. The scoring module 118 may extract the job description data from the job database 120. The scoring module 118 may extract the first resume data from the resume database 122. The scoring module 118 may convert the text information from the job description and resume to numeric form. The scoring module 118 may concatenate the decoder outputs. The scoring module 118 stores the results in the scoring database 124. The scoring module 118 determines if there are more resumes remaining in the resume database 122. If it is determined that there are more resumes remaining in the resume database 122 the scoring module 118 may extract the next resume data from the resume database 122 and the process returns to the converting the text information to numeric form. If it is determined that there are no more resumes remaining in the resume database 122 the scoring module 118 displays the scoring database 124 on the user interface 106. The scoring module 118 returns to the managing module 108.

In some cases, the hiring network 102 may include a job database 120 which contains the data that was inputted by the user during the process described in the job input module 110. For example, the database may contain a job ID, job description, keyword 1, keyword 2, keyword 3, and keyword n. The job ID provides a unique identifier for each job position listed in the chart. The job description provides a brief summary of the responsibilities and requirements of each job position. In some embodiments, the job description may be stored as a pdf document, word document, text file, etc. Keyword 1, keyword 2, keyword 3, and keyword N contain relevant keywords that are extracted from each job position. These keywords are typically related to the skills, qualifications, and experience required for each job position. The keywords may be extracted during the process described in the job parsing module 114 and stored in the database. For example, the resume parsing module 116 may extract keywords from the text of the resume, such as the name of candidate, location of the candidate, latest employer, phone number, e-mail address, soft skills, hard skills, etc.

For example, the job parsing module 114 may extract the keywords from the textual information provided in the job description. For example, a machine-learning rule-based method for text matching may be used to identify and extract keywords from the text data wherein the rules may be provided by the hiring network 102. In some embodiments, the user may select which rules, or phrases, they would like for a candidate to have and the job parsing module 114 would use the rule, by searching the cleaned text for the selected phrases, to extract the keywords or phrases. For example, the user may define the patterns they desire to search for, or it may be a selectable option in the job input module 110 provided by the hiring network 102, creating a list of dictionaries, where each dictionary contains one or more patterns. A pattern can be a single word or a sequence of words and can include various attributes such as part-of-speech tags, dependency labels, and entity types.

The job parsing module 114 may then use the inputted patterns to search the cleaned text for matches and the matches are extracted. The matches may be keywords or technical skills that are contained in the job description. In some embodiments, the keywords may be extracted using the term frequency inverse document frequency method in which a score is assigned to each word based on how often it appears and how rare it is across the document in which the words with the higher scores are deemed to be the most important words. In some embodiments, the keywords may be extracted using a textrank method in which an unsupervised graph-based algorithm is used to identify keywords in a document by representing the text document as a graph, where each sentence is a node, and the edges between nodes represent the strength of the relationship between them. The most important keywords are identified by analyzing the nodes with the highest centrality scores. In some cases, the hiring network 102 may include a job database 120 which contains the data that was inputted by the user during the process described in the job input module 110.

The resume parsing module 116 may use a named entity recognition model to recognize the entities described in the text and classify them into predefined categories, such as name of candidate, location of the candidate, latest employer, phone number, e-mail address, soft skills, hard skills, etc. The named entity recognition model may be trained using supervised learning to learn to recognize patterns in the text data that are associate with named entities, such as capitalization, context, and syntax, etc. and once trained the model may use the text data from the resume to return a structured output that identifies the named entities and their corresponding categories, such as name, location, etc. The resume parsing module 116 may use regex matching and phrase matching to extract the keywords from the structured output of the named entity recognition model.

For example, the regex matching may be used to extract the phone number and e-mail address, such as finding patterns in text data using regular expressions which are a sequence of characters that define a search pattern. For example, the sequence of characters for the phone number may be the string may start with + or (symbol, it has to be followed by a number between 1 and 9 and end with a number between 1 and 9. The sequence for the e-mail address may be finding the two parts before and after the @ symbol in which either part may consist of a series of letters, digits, and certain symbols. The resume parsing module 116 may extract the relevant hard skills and soft skills using phrase matching.

For example, a machine-learning rule-based method for text matching may be used to identify and extract keywords from the text data wherein the rules may be provided by the hiring network 102. In some embodiments, the user may select which rules, or phrases, they would like for a candidate to have and the resume parsing module 116 would use the rule, by searching the cleaned text for the selected phrases, to extract the keywords or phrases. For example, the user may define the patterns they desire to search for, or it may be a selectable option in the job input module 110 provided by the hiring network 102, creating a list of dictionaries, where each dictionary contains one or more patterns. A pattern can be a single word or a sequence of words and can include various attributes such as part-of-speech tags, dependency labels, and entity types.

The resume parsing module 114 may then use the inputted patterns to search the cleaned text for matches and the matches are extracted. The matches may be keywords or technical skills that are contained in the resume text data. In some embodiments, the keywords may be extracted using the term frequency inverse document frequency method in which a score is assigned to each word based on how often it appears and how rare it is across the document in which the words with the higher scores are deemed to be the most important words. In some embodiments, the keywords may be extracted using the textrank method in which an unsupervised graph-based algorithm is used to identify keywords in a document by representing the text document as a graph, where each sentence is a node, and the edges between nodes represent the strength of the relationship between them. The most important keywords may be identified by analyzing the nodes with the highest centrality scores. The model may also utilize a knowledge graph model in which a graph structured data is used to integrate the new data, such as the keywords from the resume text data.

Knowledge graphs may store interlinked descriptions of objects, events, situations, or abstract concepts, and encodes the semantics underlying the terminology used. For example, a knowledge graph model may be generated by linking tasks, soft skills, types of projects, etc. to hard or technical skills in which the resume parsing module 116 may use to compare keywords extracted from the resume to determine if there is a link with the keywords from the job description. This allows the hiring network 102 to determine technical skills that a job candidate may have that are mentioned or required in the job description but without the candidate specifically mentioning the skill. In some cases, the hiring network 102 may include a scoring database 124 contains the candidates and scores of each candidate for the job description inputted by user as described in the scoring module 118.

The database may contain the list of candidates and their scores which represent how closely the candidate matches the job description where 1 is not a match or less of a match and 10 is a match or indicates the candidate is closely matched to the job description. The database may be used by the user to review a plurality of candidates quickly to determine next steps for each candidate, such as no next step, request an interview with the candidate, request work examples, etc. For example, the scoring module 118 may use the text and keywords extracted from the job description and resume to evaluate the matching score between the two, such as scoring the keywords based on their relevance and importance to the job description.

The scoring model may use a longformer to generate embeddings for long sequences of text for the keywords and text of the job description and resume and then the embeddings are passed through a transformer decoder layer. For example, the longformer is a type of transformer based architecture for generating embeddings from long sequences of text designed to handle larger inputs by using a sliding window attention mechanism, where only a small subset of the tokens in the input sequence attend to each other at any given time which allows the longformer to handle much longer sequences while keeping the computational complexity manageable. For example, the transformer decoder layer may be responsible for generating the output sequence based on the encoded input sequence from the longformer in which a masked multi-head self-attention layer allows the decoder to attend to the previously generated tokens in the output sequence and a multi-head attention layer which allows the decoder to attend to the encoded representation of the input sequence.

Then the outputs from both decoder layers, one for the job description and one from the resume, may be concatenated and a special learnable token is added to the front and then passed through a transformer encoder and the output corresponding to the special learnable token is extracted and is sent through a feed forward network to obtain a matching score between 0 and 9 in which a higher score indicates a better match between the job description and the resume. For example, the transformer encoder takes a sequence of tokens as inputs and processes them through a stack of encoder layers with each layer consisting of a multi-head self-attention. The multi-head self-attention layer allows the encoder to attend to different parts of the input sequence simultaneously by computing a weighted sum of the input sequence based on the similarities of the different tokens.

For example, the feed forward network may be a type of artificial neural network that consists of multiple layers of interconnected neurons which are organized into layers and with each layer connected to the next by a set of weighted connections. The output of the encoder is passed through the feed forward network which is processes the input through the multiple layers with each layer computing a weighted sum of the inputs from the previous layer and passing the result through a nonlinear activation function and the output layer of the feed forward network produces the score between 0 and 9 in which a higher score indicates a better match between the job description and the resume.

In some cases, the hiring network 102 may include a cloud 126 which is a distributed network of computers comprising servers and databases. A cloud 126 may be a private cloud 126, where access is restricted by isolating the network such as preventing external access, or by using encryption to limit access to only authorized users. Alternatively, a cloud 126 may be a public cloud 126 where access is widely available via the internet. A public cloud 126 may not be secured or may be include limited security features. In some cases, the hiring network 102 may include a 3rd party job search network 128 which may be web-based platforms that contain potential candidates resumes, cover letters, work experience, education, skills, etc. that may be used to post a job description created in the hiring network 102 and collect interested candidates resume data. The hiring network 102 may connect to the 3rd party job search network 128 to select job candidates resumes and upload them to the hiring network 102.

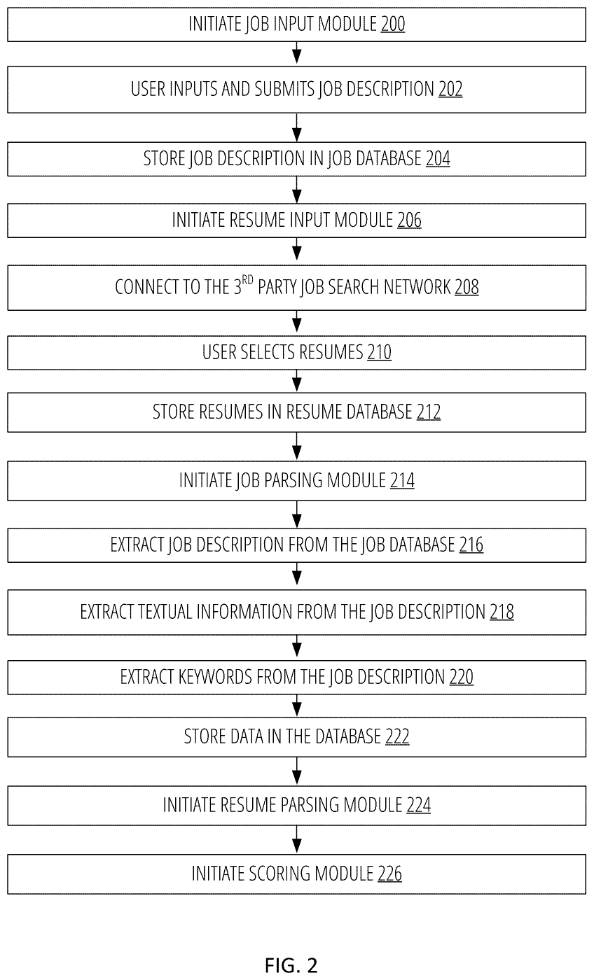

FIG. 2 illustrates an example workflow performed by a managing module, including steps performed by a job input module, a resume input module, and a job parsing module.

The process may begin with the job input module 110 being initiated, at step 200, by the managing module 108. In some embodiments, the job input module 110 may be initiated by the user selecting an option on the user interface 106, such as add job, input job, etc. The user inputs, at step 302, the job description for the job into the user interface 106. For example, the user may input the description for the job, such as the job title or position, a description of the job, qualifications for the job, required or recommended education, skills required or recommended for the job, experience level with certain software tools, etc. For example, the user may transmit data from the user interface 106 on the hiring network 102 through a user device which may include sensors, keyboards, mice, touch screens, etc. In some embodiments, the user device may be a desktop computer, laptop computer, tablet, smartphone, other portable computing device, etc.

The user device may be used by individuals to access and interact with a software application, data, and other resources hosted on a network or server. A user device may be any device that provides an interface between a user and a computer system or network. This interface may include hardware components such as a display, keyboard, and mouse or touchpad, as well as software applications that allow the user to perform tasks and access information. User devices may also include built-in sensors such as cameras, microphones, or GPS modules, which enable the device to collect data and interact with the environment in different ways. In some embodiments, a user device may also have a unique identifier or address that allows it to be recognized and tracked on a network. This identifier may be a hardware-specific identifier such as a MAC address or a software-specific identifier such as an IP address.

The user inputs and submits, at step 202, the job description for the job through the user interface 106. For example, once the user inputs the job description for the job the user may submit the job on the hiring network 102 to save and store the inputted job description. For example, the user may transmit data from the user interface 106 on the hiring network 102 through a user device which may include sensors, keyboards, mice, touch screens, etc. In some embodiments, the user device may be a desktop computer, laptop computer, tablet, smartphone, other portable computing device, etc. The user device may be used by individuals to access and interact with a software application, data, and other resources hosted on a network or server.

A user device may be any device that provides an interface between a user and a computer system or network. This interface may include hardware components such as a display, keyboard, and mouse or touchpad, as well as software applications that allow the user to perform tasks and access information. User devices may also include built-in sensors such as cameras, microphones, or GPS modules, which enable the device to collect data and interact with the environment in different ways. In some embodiments, a user device may also have a unique identifier or address that allows it to be recognized and tracked on a network. This identifier may be a hardware-specific identifier such as a MAC address or a software-specific identifier such as an IP address.

The job input module 110 may store, at step 204, the job description in the job database 120. For example, the data inputted by the user may be stored in the job database 120, such as the job title or position, a description of the job, qualifications for the job, required or recommended education, skills required or recommended for the job, experience level with certain software tools, etc. The job input module 110 returns to the managing module 108. For example, once the user submits the job description and the job input module 110 stores the collected data in the job database 120 the job input module 110 returns to the managing module 108. In some embodiments, the user may be able to save the progress they made on the job description and return to edit or complete the job description at a later time.

TABLE 1
Example Job Database

| Job ID | Job Description | Keyword 1 | Keyword 2 | Keyword 3 | Keyword N |
|---|---|---|---|---|---|
| SD001 | Software Developer | Java | Python | Agile | Software Engineering |
| SD002 | Data Analyst | SQL | Data Visualization | Data Mining | Statistical Analysis |
| SD003 | Web Developer | HTML | CSS | JavaScript | Responsive Design |
| — | — | — | — | — | — |
| — | — | — | — | — | — |
| — | — | — | — | — | — |

The job database 120 may contain the data that was inputted by the user during the process described in the job input module 110. For example, the database may contain a job ID, job description, keyword 1, keyword 2, keyword 3, and keyword n. The job ID provides a unique identifier for each job position listed in the chart. The job description provides a brief summary of the responsibilities and requirements of each job position. In some embodiments, the job description may be stored as a pdf document, word document, text file, etc. Keyword 1, keyword 2, keyword 3, and keyword N contain relevant keywords that are extracted from each job position. These keywords are typically related to the skills, qualifications, and experience required for each job position.

The keywords may be extracted during the process described in the job parsing module 114 and stored in the database. For example, the job parsing module 114 may extract the keywords from the textual information provided in the job description. For example, a machine-learning rule-based method for text matching may be used to identify and extract keywords from the text data wherein the rules may be provided by the hiring network 102. In some embodiments, the user may select which rules, or phrases, they would like for a candidate to have and the job parsing module 114 would use the rule, by searching the cleaned text for the selected phrases, to extract the keywords or phrases.

For example, the user may define the patterns they desire to search for, or it may be a selectable option in the job input module 110 provided by the hiring network 102, creating a list of dictionaries, where each dictionary contains one or more patterns. A pattern can be a single word or a sequence of words and can include various attributes such as part-of-speech tags, dependency labels, and entity types. The job parsing module 114 may then use the inputted patterns to search the cleaned text for matches and the matches are extracted. The matches may be keywords or technical skills that are contained in the job description.

In some embodiments, the keywords may be extracted using the term frequency inverse document frequency method in which a score is assigned to each word based on how often it appears and how rare it is across the document in which the words with the higher scores are deemed to be the most important words. In some embodiments, the keywords may be extracted using the textrank method in which an unsupervised graph-based algorithm is used to identify keywords in a document by representing the text document as a graph, where each sentence is a node, and the edges between nodes represent the strength of the relationship between them. The most important keywords are identified by analyzing the nodes with the highest centrality scores.

The process may continue with the resume input module 112 being initiated, at step 206, by the managing module 108. The resume input module 112 may connect, at step 208, to the 3rd party job search network 128. For example, the resume input module 112 may connect to a 3rd party job search network 128 which may be web-based platforms that contain potential candidates resumes, cover letters, work experience, education, skills, etc. that may be used to post a job description created in the hiring network 102 and collect interested candidates resume data. The hiring network 102 may connect to the 3rd party job search network 128 to select job candidates resumes and upload them to the hiring network 102.

The user may select, at step 210, the resumes through the connection to the 3rd party job search network 128. For example, the user may select resumes to be stored in the resume database 122 by selecting the desired resumes on the 3rd party job search network 128 and uploading the resume data to the hiring network 102. In some embodiments, the resume data may be the text document which contains the resume, such as a document stored as file such as a docx, pdf, doc, txt file. In some embodiments, the file may include images of resumes. In some embodiments, the resume data may be a candidate's resume or cover letter containing personal information, such as name and address, professional information, such as previous employment and associated tasks or responsibilities, educational information, such as schools or universities attended and the achieved level of education, additional skills, such as technical skills, project management skills, managerial skills, etc. that have been acquired through their educational and professional careers, etc.

TABLE 2
Example Resume Database

| | | Latest | | | | | |
|---|---|---|---|---|---|---|---|
| Name | Location | Employer | Phone Number | Email Address | Keyword 1 | Keyword 2 | Keyword N |
| John Smith | New York | Google | (555) 555-1234 | john.smith@gmail.com | Java | Python | Agile |
| Emily Chen | San Francisco | Microsoft | (555) 555-5678 | emily.chen@gmail.com | Java | Software | Object-Oriented |
| | | | | | | Engineering | Programming |
| Michael Johnson | Seattle | Amazon | (555) 555-9101 | michael.johnson@gmail.com | Python | SQL | Data Analysis |
| Sarah Kim | Chicago | IBM | (555) 555-2468 | sarah.kim@gmail.com | Agile | Sorum | Software |
| | | | | | | | Development |
| | | | | | | | Lifecycle |
| — | — | — | — | — | — | — | — |
| — | — | — | — | — | — | — | — |
| — | — | — | — | — | — | — | — |

The resume database 122 contains the data that was inputted by the user during the process described in the job input module 110. For example, the database may contain a job ID, job description, keyword 1, keyword 2, keyword 3, and keyword n. The job ID provides a unique identifier for each job position listed in the chart. The job description provides a brief summary of the responsibilities and requirements of each job position. In some embodiments, the job description may be stored as a pdf document, word document, text file, etc. Keyword 1, keyword 2, keyword 3, and keyword N contain relevant keywords that are extracted from each job position. These keywords are typically related to the skills, qualifications, and experience required for each job position.

The keywords may be extracted during the process described in the job parsing module 114 and stored in the database. For example, the resume parsing module 116 may extract keywords from the text of the resume, such as the name of candidate, location of the candidate, latest employer, phone number, e-mail address, soft skills, hard skills, etc. The resume parsing module 116 may use a named entity recognition model to recognize the entities described in the text and classify them into predefined categories, such as name of candidate, location of the candidate, latest employer, phone number, e-mail address, soft skills, hard skills, etc. The named entity recognition model may be trained using supervised learning to learn to recognize patterns in the text data that are associate with named entities, such as capitalization, context, and syntax, etc. and once trained the model may use the text data from the resume to return a structured output that identifies the named entities and their corresponding categories, such as name, location, etc.

The resume parsing module 116 may use regex matching and phrase matching to extract the keywords from the structured output of the named entity recognition model. For example, the regex matching may be used to extract the phone number and e-mail address, such as finding patterns in text data using regular expressions which are a sequence of characters that define a search pattern. For example, the sequence of characters for the phone number may be the string may start with + or (symbol, it has to be followed by a number between 1 and 9 and end with a number between 1 and 9. The sequence for the e-mail address may be finding the two parts before and after the @ symbol in which either part may consist of a series of letters, digits, and certain symbols. The resume parsing module 116 may extract the relevant hard skills and soft skills using phrase matching. For example, a machine-learning rule-based method for text matching may be used to identify and extract keywords from the text data wherein the rules may be provided by the hiring network 102.

In some embodiments, the user may select which rules, or phrases, they would like for a candidate to have and the resume parsing module 116 would use the rule, by searching the cleaned text for the selected phrases, to extract the keywords or phrases. For example, the user may define the patterns they desire to search for, or it may be a selectable option in the job input module 110 provided by the hiring network 102, creating a list of dictionaries, where each dictionary contains one or more patterns. A pattern can be a single word or a sequence of words and can include various attributes such as part-of-speech tags, dependency labels, and entity types. The resume parsing module 114 may then use the inputted patterns to search the cleaned text for matches and the matches are extracted. The matches may be keywords or technical skills that are contained in the resume text data. In some embodiments, the keywords may be extracted using the term frequency inverse document frequency method in which a score is assigned to each word based on how often it appears and how rare it is across the document in which the words with the higher scores are deemed to be the most important words.

In some embodiments, the keywords may be extracted using the textrank method in which an unsupervised graph-based algorithm is used to identify keywords in a document by representing the text document as a graph, where each sentence is a node, and the edges between nodes represent the strength of the relationship between them. The most important keywords are identified by analyzing the nodes with the highest centrality scores. The model may also utilize a knowledge graph model in which a graph structured data is used to integrate the new data, such as the keywords from the resume text data. Knowledge graphs store interlinked descriptions of objects, events, situations, or abstract concepts, and encodes the semantics underlying the terminology used. For example, a knowledge graph model may be generated by linking tasks, soft skills, types of projects, etc. to hard or technical skills in which the resume parsing module 116 may use to compare keywords extracted from the resume to determine if there is a link with the keywords from the job description. This allows the hiring network 102 to determine technical skills that a job candidate may have that are mentioned or required in the job description but without the candidate specifically mentioning the skill.

The resume input module 112 may store, at step 212, the selected resumes in the resume database 122. In some embodiments, the resume data may be the text document which contains the resume, such as a document stored as file such as a docx, pdf, doc, txt file. In some embodiments, the file may include images of resumes. In some embodiments, the resume data may be a candidate's resume or cover letter containing personal information, such as name and address, professional information, such as previous employment and associated tasks or responsibilities, educational information, such as schools or universities attended and the achieved level of education, additional skills, such as technical skills, project management skills, managerial skills, etc. that have been acquired through their educational and professional careers, etc. The resume input module 112 returns, at step 408, to the managing module 108.

The process may continue with the job parsing module 114 being initiated, at step 214, by the managing module 108. In some embodiments, the job parsing module 114 may be initiated once the job description is inputted by the user in the process described in the job input module 110. The job parsing module 114 may extract, at step 216, the job description from the job database 120. For example, the job parsing module 114 may extract the job description from the job database 120 which may be inputted and stored on the hiring network 102, be uploaded by the user in a pdf, word document, text document, etc.

The job parsing module 114 may extract, at step 218, the textual information from the job description. For example, the job parsing module 114 may extract the textual information from the job description by only extracting the cleaned text of the job description. For example, the cleaned text does not contain any unwanted characters or irrelevant information and helps in assisting improve the accuracy and effectiveness of extracting the keywords from the job description. In some embodiments, the textual information may be extracted through text scrapping in which software is used to extract text.

In some embodiments, the textual information may be extracted through optical character recognition which is a technique that involves converting scanned images or PDFs into machine readable text. In some embodiments, the textual information may be extracted through an information extraction technique in which specific pieces of information are identified and extracted from the text. In some embodiments, the textual information may be extracted through topic modeling in which topics or themes are identified in a plurality of text.

The job parsing module 114 may extract, at step 220, the keywords from the job description. For example, the job parsing module 114 may extract the keywords from the textual information provided in the job description. For example, a machine-learning rule-based method for text matching may be used to identify and extract keywords from the text data wherein the rules may be provided by the hiring network 102. In some embodiments, the user may select which rules, or phrases, they would like for a candidate to have and the job parsing module 114 would use the rule, by searching the cleaned text for the selected phrases, to extract the keywords or phrases. For example, the user may define the patterns they desire to search for, or it may be a selectable option in the job input module 110 provided by the hiring network 102, creating a list of dictionaries, where each dictionary contains one or more patterns. A pattern can be a single word or a sequence of words and can include various attributes such as part-of-speech tags, dependency labels, and entity types.

The job parsing module 114 may then use the inputted patterns to search the cleaned text for matches and the matches are extracted. The matches may be keywords or technical skills that are contained in the job description. In some embodiments, the keywords may be extracted using the term frequency inverse document frequency method in which a score is assigned to each word based on how often it appears and how rare it is across the document in which the words with the higher scores are deemed to be the most important words. In some embodiments, the keywords may be extracted using the textrank method in which an unsupervised graph-based algorithm is used to identify keywords in a document by representing the text document as a graph, where each sentence is a node, and the edges between nodes represent the strength of the relationship between them.

The most important keywords may be identified by analyzing the nodes with the highest centrality scores. In some embodiments, the keywords may be extracted using a frequency based method in which the most frequently occurring keywords are extracted as the keywords. In some embodiments, the keywords may be extracted using Latent Dirichlet Allocation (LDA) which is a topic modeling algorithm that identifies topics in a plurality of documents that can be used to extract keywords by identifying the most probable words associated with each topic. For example, this algorithm may be implemented using a job description inputted by the user as well as the plurality of job descriptions of current employers who hold the same position to determine the keywords for the open job position.

The job parsing module 114 stores, at step 222, the data in the job database 120. For example, the job parsing module 114 stores the data, such as the cleaned text of the job description and the list of keywords in the job database 120. For example, the database may contain a job ID, job description, keyword 1, keyword 2, keyword 3, and keyword n. The job ID provides a unique identifier for each job position listed in the chart. The job description provides a brief summary of the responsibilities and requirements of each job position. In some embodiments, the job description may be stored as a pdf document, word document, text file, etc. Keyword 1, keyword 2, keyword 3, and keyword N contain relevant keywords that are extracted from each job position. These keywords are typically related to the skills, qualifications, and experience required for each job position. The keywords may be extracted during the process described in the job parsing module 114 and stored in the database. The job parsing module 114 may return to the managing module 108.

The managing module 108 may initiate, at step 224, the resume parsing module 116. For example, the resume parsing module 116 may begin by being initiated by the managing module 108. The resume parsing module 116 may extract the first resume from the resume database 122. The resume parsing module 116 may extract the textual information from the resume. The resume parsing module 116 identifies the language the resume is written in. The resume parsing module 116 may determine if the resume is written in English. If it is determined that the resume is not written in English the resume parsing module 116 translates the resume to English. If it is determined that the resume is written in English or after the resume is translated to English the resume parsing module 116 performs segmentation on the resume. The resume parsing module 116 may extract the keywords from the resume.

The resume parsing module 116 may store the data in the resume database 122. The resume parsing module 116 may determine if there are more resumes remaining in the resume database 122. If it is determined that there are more resumes remaining in the resume database 122 the resume parsing module 116 may extract the next resume from the resume database 122 and the process returns to extracting the textual information from the resume. If it is determined that there are no more resumes remaining in the resume database 122 the resume parsing module 116 returns to the managing module 108.

The managing module 108 may initiate, at step 226, the scoring module 118. For example, the scoring module 118 may begin by being initiated by the managing module 108. The scoring module 118 may extract the job description data from the job database 120. The scoring module 118 may extract the first resume data from the resume database 122. The scoring module 118 may convert the text information from the job description and resume to numeric form. The scoring module 118 may concatenate the decoder outputs. The scoring module 118 may store the results in the scoring database 124.

The scoring module 118 may determine if there are more resumes remaining in the resume database 122. If it is determined that there are more resumes remaining in the resume database 122 the scoring module 118 may extract the next resume data from the resume database 122 and the process returns to the converting the text information to numeric form. If it is determined that there are no more resumes remaining in the resume database 122 the scoring module 118 displays the scoring database 124 on the user interface 106. The scoring module 118 may return to the managing module 108.

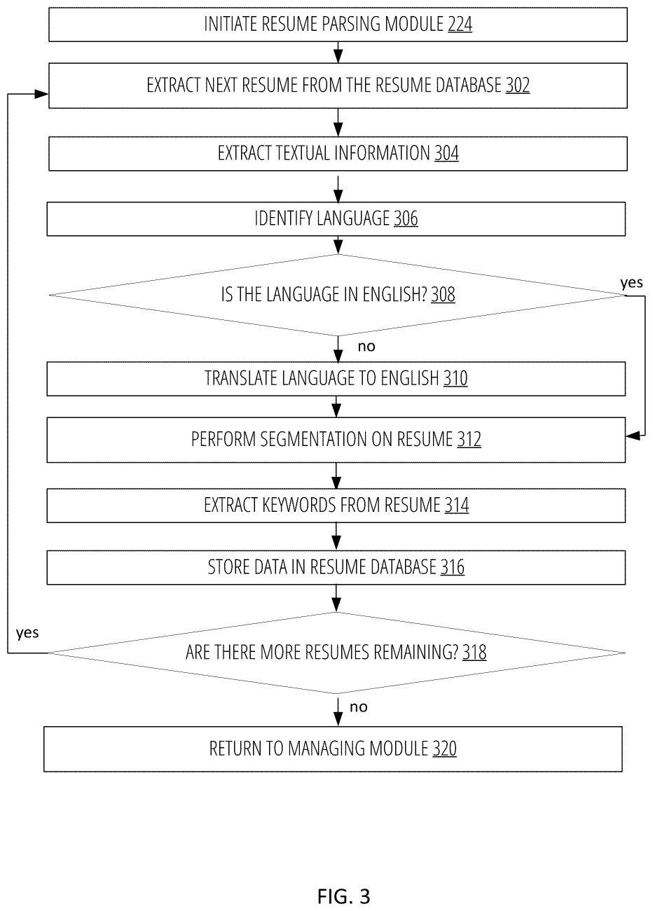

FIG. 3 illustrates an example workflow performed by a resume parsing module.

The process may begin with the resume parsing module 116 being initiated, at step 224, by the managing module 108. The resume parsing module 116 may extract, at step 302, the data for the first resume from the resume database 122. For example, the resume parsing module 116 may extract the resume data from the first resume, such as the uploaded document that was stored on the hiring network 102 by the user. For example, the resume document may be the text document which contains the resume, such as a document stored as file such as a docx, pdf, doc, txt file. In some embodiments, the file may include images of resumes.

The resume parsing module 116 may extract, at step 304, the textual information from the resume. For example, the resume parsing module 116 may extract the textual information from the resume document by only extracting the cleaned text of the resume document. For example, the cleaned text does not contain any unwanted characters or irrelevant information and helps in assisting improve the accuracy and effectiveness of extracting the keywords from the resume.

In some embodiments, the textual information may be extracted through text scrapping in which software is used to extract text. In some embodiments, the textual information may be extracted through optical character recognition which is a technique that involves converting scanned images or PDFs into machine-readable text. In some embodiments, the textual information may be extracted through an information extraction technique in which specific pieces of information are identified and extracted from the text. In some embodiments, the textual information may be extracted through topic modeling in which topics or themes are identified in a plurality of text.

The resume parsing module 116 identifies, at step 306, the language the resume is written in. For example, the resume parsing module 116 may identify the language in which the resume is written by using a N-gram language detection method. The N-gram language detection method analyzes the frequency of character n-grams, for example the sequences of n characters, in the text and compares them to the frequency of n-grams in a pre-defined language model and the language model with the highest probability of generating the observed n-grams is the language of the text.

In some embodiments, the resume parsing module 116 may us a dictionary-based language detection, statistical language detection, machine learning based language detection, etc. to determine the language of the resume. For example, the resume parsing module 116 may compare the words in the text to a dictionary of known words for each language and the language with the highest number of matched words is determined to be the language of the text. For example, the resume parsing module 116 may analyze the statistical properties of the text, such as the word frequency and sentence structure, to determine the language of the text. For example, the resume parsing module 116 may train a machine learning model on large database of texts in a plurality of languages and then use the trained model to predict the language of the inputted text based on the linguistic features.

The resume parsing module 116 determines, at step 308, if the resume is written in English. For example, the resume parsing module 116 may determine the resume is written in English if the output of the n-gram language detection method is English, if the output is any other language then the resume parsing module 116 can determine that the resume is written in another language. For example, the resume parsing module 116 may identify the language in which the resume is written by using a N-gram language detection method. The N-gram language detection method analyzes the frequency of character n-grams, for example the sequences of n characters, in the text and compares them to the frequency of n-grams in a pre-defined language model and the language model with the highest probability of generating the observed n-grams is the language of the text.

In some embodiments, the resume parsing module 116 may us a dictionary-based language detection, statistical language detection, machine learning based language detection, etc. to determine the language of the resume. For example, the resume parsing module 116 may compare the words in the text to a dictionary of known words for each language and the language with the highest number of matched words is determined to be the language of the text. For example, the resume parsing module 116 may analyze the statistical properties of the text, such as the word frequency and sentence structure, to determine the language of the text. For example, the resume parsing module 116 may train a machine learning model on large database of texts in a plurality of languages and then use the trained model to predict the language of the inputted text based on the linguistic features.

If it is determined that the resume is not written in English the resume parsing module 116 translates, at step 310, the resume to English. For example, the resume parsing module 116 may use a neural machine translation in which a deep neural network is trained to learn how to translate text from one language to another. For example, the resume parsing module 116 may utilize an API, or application programming interface, to connect to a 3rd party translation network, such as Google Translate, and send the text data of the resume to translate the document to English. In some embodiments, the text may be translated by using rules based machine translation in which a set of linguistic rules to translate text from one language to another.

In some embodiments, the text may be translated by using statistical machine translation in which a machine learning model is trained on a plurality of parallel texts in two languages and uses statistical techniques to identify patterns and translate the text from one language to another. In some embodiments, the text may be translated by using neural machine translation in which artificial neural networks are used to translate text from one language to another. In some embodiments, the text may be translated by using phrase-based machine translation in which the source is broken down into smaller phrases and translates each phrase. In some embodiments, the text may be translated by using hybrid machine translation in which multiple machine translation methods are combined to improve the quality of the translation, such as combining a machine-learning rule-based machine translation method and statistical machine translation method.

If it is determined that the resume is written in English or after the resume is translated to English the resume parsing module 116 performs, at step 312, segmentation on the resume. For example, the resume parsing module 116 may divide the resume based on a plurality of titles, such as personal information, experience, objectives, education, etc. and provide the information specific to each section to segment the resume. For example, the resume parsing module 116 may use a zero shot classification model which classifies text into categories by using the knowledge of the relationships between words and concepts to generalize to categories which are specified in advance. The model is trained by learning to encode the meaning of words and phrases in a high dimensional vector space that allows it to identify the relationships between concepts and classify the text into categories.

The resume parsing module 116 may extract, at step 314, the keywords from the resume. For example, the resume parsing module 116 may extract keywords from the text of the resume, such as the name of candidate, location of the candidate, latest employer, phone number, e-mail address, soft skills, hard skills, etc. The resume parsing module 116 may use a named entity recognition model to recognize the entities described in the text and classify them into predefined categories, such as name of candidate, location of the candidate, latest employer, phone number, e-mail address, soft skills, hard skills, etc. The named entity recognition model may be trained using supervised learning to learn to recognize patterns in the text data that are associate with named entities, such as capitalization, context, and syntax, etc. and once trained the model may use the text data from the resume to return a structured output that identifies the named entities and their corresponding categories, such as name, location, etc.

The resume parsing module 116 may use regex matching and phrase matching to extract the keywords from the structured output of the named entity recognition model. For example, the regex matching may be used to extract the phone number and e-mail address, such as finding patterns in text data using regular expressions which are a sequence of characters that define a search pattern. For example, the sequence of characters for the phone number may be the string may start with + or (symbol, it has to be followed by a number between 1 and 9 and end with a number between 1 and 9. The sequence for the e-mail address may be finding the two parts before and after the @ symbol in which either part may consist of a series of letters, digits, and certain symbols.

The resume parsing module 116 may extract the relevant hard skills and soft skills using phrase matching. For example, a machine-learning rule-based method for text matching may be used to identify and extract keywords from the text data wherein the rules may be provided by the hiring network 102. In some embodiments, the user may select which rules, or phrases, they would like for a candidate to have and the resume parsing module 116 would use the rule, by searching the cleaned text for the selected phrases, to extract the keywords or phrases. For example, the user may define the patterns they desire to search for, or it may be a selectable option in the job input module 110 provided by the hiring network 102, creating a list of dictionaries, where each dictionary contains one or more patterns. A pattern can be a single word or a sequence of words and can include various attributes such as part-of-speech tags, dependency labels, and entity types.

The resume parsing module 114 may then use the inputted patterns to search the cleaned text for matches and the matches are extracted. The matches may be keywords or technical skills that are contained in the resume text data. In some embodiments, the keywords may be extracted using the term frequency inverse document frequency method in which a score is assigned to each word based on how often it appears and how rare it is across the document in which the words with the higher scores are deemed to be the most important words. In some embodiments, the keywords may be extracted using the textrank method in which an unsupervised graph-based algorithm is used to identify keywords in a document by representing the text document as a graph, where each sentence is a node, and the edges between nodes represent the strength of the relationship between them. The most important keywords are identified by analyzing the nodes with the highest centrality scores.

The model may also utilize a knowledge graph model in which a graph structured data is used to integrate the new data, such as the keywords from the resume text data. Knowledge graphs store interlinked descriptions of objects, events, situations, or abstract concepts, and encodes the semantics underlying the terminology used. For example, a knowledge graph model may be generated by linking tasks, soft skills, types of projects, etc. to hard or technical skills in which the resume parsing module 116 may use to compare keywords extracted from the resume to determine if there is a link with the keywords from the job description. This allows the hiring network 102 to determine technical skills that a job candidate may have that are mentioned or required in the job description but without the candidate specifically mentioning the skill.

The resume parsing module 116 may store, at step 316, the data in the resume database 122. For example, the resume parsing module 116 stores the data from the keyword extraction in the resume database 122, such as the candidate's name, location, latest employer, phone number, email address, and a plurality of keywords, such as keyword 1, keyword 2, and keyword n. The job ID provides a unique identifier for each job position listed in the chart. The job description provides a brief summary of the responsibilities and requirements of each job position.

In some embodiments, the job description may be stored as a pdf document, word document, text file, etc. Keyword 1, keyword 2, keyword 3, and keyword N contain relevant keywords that are extracted from each job position. These keywords are typically related to the skills, qualifications, and experience required for each job position. The resume parsing module 116 may determine, at step 318, if there are more resumes remaining in the resume database 122. For example, the resume parsing module 116 determines if all of the resumes stored in the resume database 122 have the necessary data fields, such as name, location, latest employer, etc. and if these fields are empty or invalid then the resume parsing module 116 selects the data entry and may extract the resume document from the resume database 122. If it is determined that there are more resumes remaining in the resume database 122 the resume parsing module 116 may extract, at step 320, the next resume from the resume database 122 and the process returns to extracting the textual information from the resume. If it is determined that there are no more resumes remaining in the resume database 122 the resume parsing module 116 may return to the managing module 108.

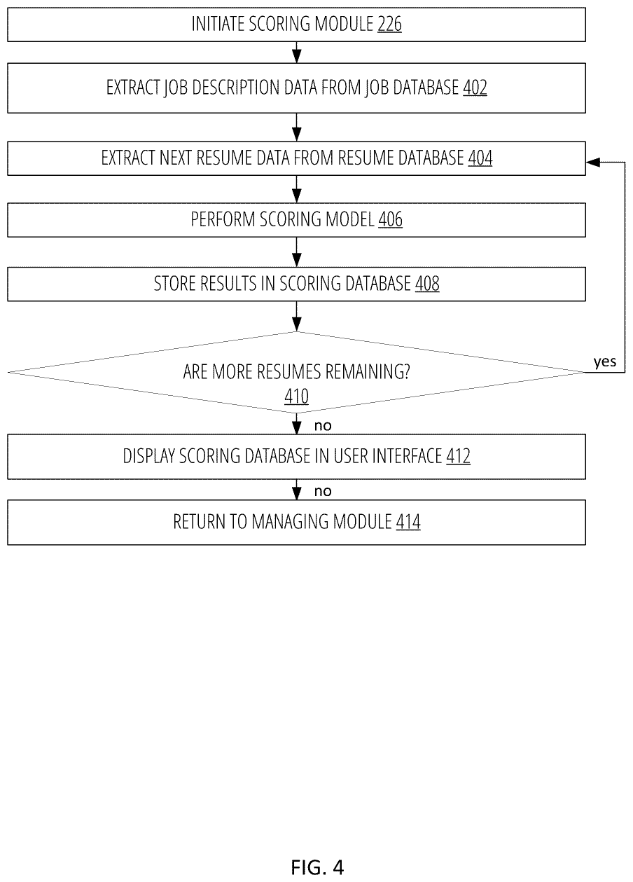

FIG. 4 illustrates an example workflow performed by the scoring module 118.

The process may begin with the scoring module 118 being initiated, at step 226, by the managing module 108. In some embodiments, the scoring module 118 may be initiated once the job parsing module 114 and the resume parsing module 116 have been completed. The scoring module 118 may extract, at step 402, the job description data from the job database 120. For example, the scoring module may extract the job ID, job description, keyword 1, keyword 2, keyword 3, and keyword n from the job database 120. The job ID provides a unique identifier for each job position listed in the chart. The job description provides a brief summary of the responsibilities and requirements of each job position. In some embodiments, the job description may be stored as a pdf document, word document, text file, etc. Keyword 1, keyword 2, keyword 3, and keyword N contain relevant keywords that are extracted from each job position. These keywords are typically related to the skills, qualifications, and experience required for each job position. The keywords may be extracted during the process described in the job parsing module 114 and stored in the database.

The scoring module 118 may extract, at step 404, the first resume data from the resume database 122. For example, the scoring module may extract the candidate ID, the resume document, name, location, latest employer, phone number, email address, keyword 1, keyword 2, and keyword n from the first resume stored in the resume database 122. For example, the database may contain a job ID, job description, keyword 1, keyword 2, keyword 3, and keyword n. The job ID provides a unique identifier for each job position listed in the chart. The job description provides a brief summary of the responsibilities and requirements of each job position. In some embodiments, the job description may be stored as a pdf document, word document, text file, etc. Keyword 1, keyword 2, keyword 3, and keyword N contain relevant keywords that are extracted from each job position. These keywords are typically related to the skills, qualifications, and experience required for each job position. The keywords may be extracted during the process described in the job parsing module 114 and stored in the database.

The scoring module 118 may perform, at step 406, the scoring model on the resume. For example, the scoring module 118 may use the text and keywords extracted from the job description and resume to evaluate the matching score between the two, such as scoring the keywords based on their relevance and importance to the job description. The scoring model may use a longformer to generate embeddings for long sequences of text for the keywords and text of the job description and resume and then the embeddings are passed through a transformer decoder layer. For example, the longformer is a type of transformer based architecture for generating embeddings from long sequences of text designed to handle larger inputs by using a sliding window attention mechanism, where only a small subset of the tokens in the input sequence attend to each other at any given time which allows the longformer to handle much longer sequences while keeping the computational complexity manageable.

For example, the transformer decoder layer may be responsible for generating the output sequence based on the encoded input sequence from the longformer in which a masked multi-head self-attention layer allows the decoder to attend to the previously generated tokens in the output sequence and a multi-head attention layer which allows the decoder to attend to the encoded representation of the input sequence. Then the outputs from both decoder layers, one for the job description and one from the resume, are then concatenated and a special learnable token is added to the front and then passed through a transformer encoder and the output corresponding to the special learnable token is extracted and is sent through a feed forward network to obtain a matching score between 0 and 9 in which a higher score indicates a better match between the job description and the resume.

For example, the transformer encoder takes a sequence of tokens as inputs and processes them through a stack of encoder layers with each layer consisting of a multi-head self-attention. The multi-head self-attention layer allows the encoder to attend to different parts of the input sequence simultaneously by computing a weighted sum of the input sequence based on the similarities of the different tokens. For example, the feed forward network may be a type of artificial neural network that consists of multiple layers of interconnected neurons which are organized into layers and with each layer connected to the next by a set of weighted connections. The output of the encoder is passed through the feed forward network which is processes the input through the multiple layers with each layer computing a weighted sum of the inputs from the previous layer and passing the result through a nonlinear activation function and the output layer of the feed forward network produces the score between 0 and 9 in which a higher score indicates a better match between the job description and the resume.

The scoring module 118 stores, at step 408, the results in the scoring database 124. For example, the scoring module 118 stores the results from the scoring model in the scoring database 124, such as the candidate and their scores which represent how closely the candidate matches the job description. The database contains the list of candidates and their scores which represent how closely the candidate matches the job description where 1 is not a match or less of a match and 10 is a match or indicates the candidate is closely matched to the job description. The database may be used by the user to review a plurality of candidates quickly to determine next steps for each candidate, such as no next step, request an interview with the candidate, request work examples, etc.

The scoring module 118 determines, at step 410, if there are more resumes remaining in the resume database 122. For example, the scoring module 118 determines if all of the resumes stored in the resume database 122 have been processed by the scoring model, such as by comparing the number of data entries in the resume database 122 and the scoring database 124 and if there is not a match then there are more resumes remaining in the resume database 122. If it is determined that there are more resumes remaining in the resume database 122 the scoring module 118 may extract the next resume data from the resume database 122 and the process returns to the performing the scoring model on the next resume and the original job description. If it is determined that there are no more resumes remaining in the resume database 122 the scoring module 118 displays, at step 414, the scoring database 124 on the user interface 106. For example, the scoring module 118 may display the scoring database 124 on the user interface 106 allowing a user of the hiring network 102 to review the candidates for the job description more quickly and efficiently. The user may review the score of the candidates, be able to see the skills of the candidate, for example the program languages they have experience with, location, employment history, view the candidates resume or cover letter, etc. The scoring module 118 returns, at step 416, to the managing module 108.

TABLE 3
Example Scoring Database

| Candidate ID | Name | Score |
|---|---|---|
| 001C01 | John Smith | 8 |
| 001C02 | Emily Chen | 9 |
| 001C03 | Michael Johnson | 7 |
| 001C04 | Sarah Kim | 6 |
| — | — | — |
| — | — | — |
| — | — | — |

The scoring database 124 may contain the candidates and scores of each candidate for the job description inputted by user as described in the scoring module 118. The database contains the list of candidates and their scores which represent how closely the candidate matches the job description where 1 is not a match or less of a match and 10 is a match or indicates the candidate is closely matched to the job description. The database may be used by the user to review a plurality of candidates quickly to determine next steps for each candidate, such as no next step, request an interview with the candidate, request work examples, etc. For example, the scoring module 118 may use the text and keywords extracted from the job description and resume to evaluate the matching score between the two, such as scoring the keywords based on their relevance and importance to the job description.

The scoring model may use a longformer to generate embeddings for long sequences of text for the keywords and text of the job description and resume and then the embeddings are passed through a transformer decoder layer. For example, the longformer is a type of transformer based architecture for generating embeddings from long sequences of text designed to handle larger inputs by using a sliding window attention mechanism, where only a small subset of the tokens in the input sequence attend to each other at any given time which allows the longformer to handle much longer sequences while keeping the computational complexity manageable. For example, the transformer decoder layer may be responsible for generating the output sequence based on the encoded input sequence from the longformer in which a masked multi-head self-attention layer allows the decoder to attend to the previously generated tokens in the output sequence and a multi-head attention layer which allows the decoder to attend to the encoded representation of the input sequence.

Then the outputs from both decoder layers, one for the job description and one from the resume, are then concatenated and a special learnable token is added to the front and then passed through a transformer encoder and the output corresponding to the special learnable token is extracted and is sent through a feed forward network to obtain a matching score between 0 and 9 in which a higher score indicates a better match between the job description and the resume. For example, the transformer encoder takes a sequence of tokens as inputs and processes them through a stack of encoder layers with each layer consisting of a multi-head self-attention. The multi-head self-attention layer allows the encoder to attend to different parts of the input sequence simultaneously by computing a weighted sum of the input sequence based on the similarities of the different tokens.

For example, the feed forward network may be a type of artificial neural network that consists of multiple layers of interconnected neurons which are organized into layers and with each layer connected to the next by a set of weighted connections. The output of the encoder is passed through the feed forward network which is processes the input through the multiple layers with each layer computing a weighted sum of the inputs from the previous layer and passing the result through a nonlinear activation function and the output layer of the feed forward network produces the score between 0 and 9 in which a higher score indicates a better match between the job description and the resume.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

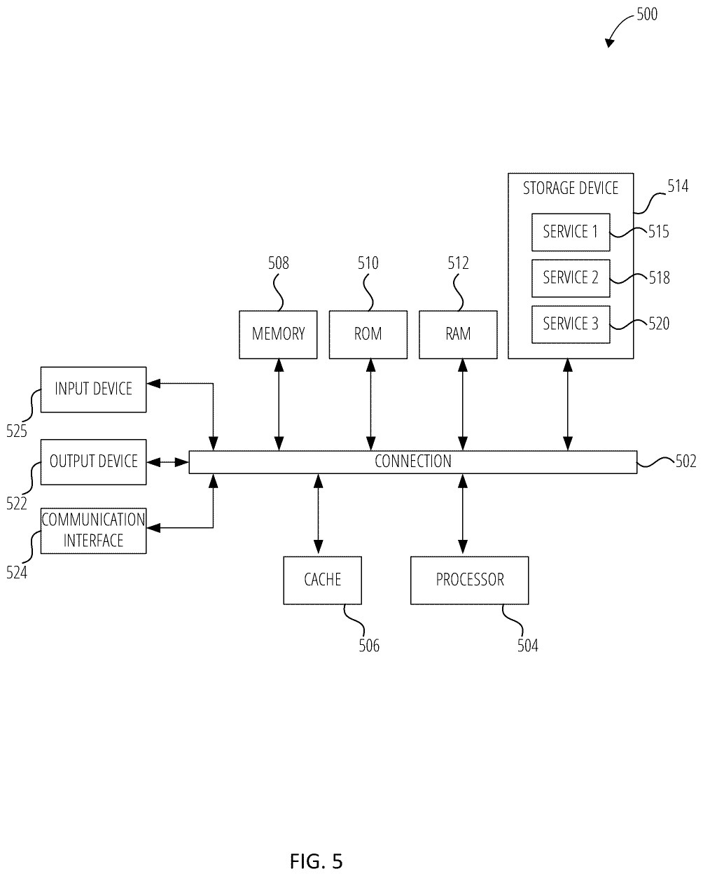

FIG. 5 shows an example of computing system 500, which can be for example any computing device making up education network 102, or any component thereof in which the components of the system are in communication with each other using connection 502. Connection 502 can be a physical connection via a bus, or a direct connection into processor 504, such as in a chipset architecture. Connection 502 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 500 includes at least one processing unit (CPU or processor) 504 and connection 502 that couples various system components including system memory 508, such as read-only memory (ROM) 510 and random access memory (RAM) 512 to processor 504. Computing system 500 can include a cache of high-speed memory 508 connected directly with, in close proximity to, or integrated as part of processor 504.

Processor 504 can include any general purpose processor and a hardware service or software service, such as services 506, 518, and 520 stored in storage device 514, configured to control processor 504 as well as a special-purpose processor where software instructions are incorporated into the actual processor design. Processor 504 may essentially be a completely self-contained computing system, containing multiple cores or processors, a bus, memory controller, cache, etc. A multi-core processor may be symmetric or asymmetric.

To enable user interaction, computing system 500 includes an input device 526, which can represent any number of input mechanisms, such as a microphone for speech, a touch-sensitive screen for gesture or graphical input, keyboard, mouse, motion input, speech, etc. Computing system 500 can also include output device 522, which can be one or more of a number of output mechanisms known to those of skill in the art. In some instances, multimodal systems can enable a user to provide multiple types of input/output to communicate with computing system 500. Computing system 500 can include communication interface 524, which can generally govern and manage the user input and system output. There is no restriction on operating on any particular hardware arrangement, and therefore the basic features here may easily be substituted for improved hardware or firmware arrangements as they are developed.

Storage device 514 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 514 can include software services, servers, services, etc., that when the code that defines such software is executed by the processor 504, it causes the system to perform a function. In some embodiments, a hardware service that may deploy a particular function can include the software component stored in a computer-readable medium in connection with the hardware components, such as processor 504, connection 502, output device 522, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

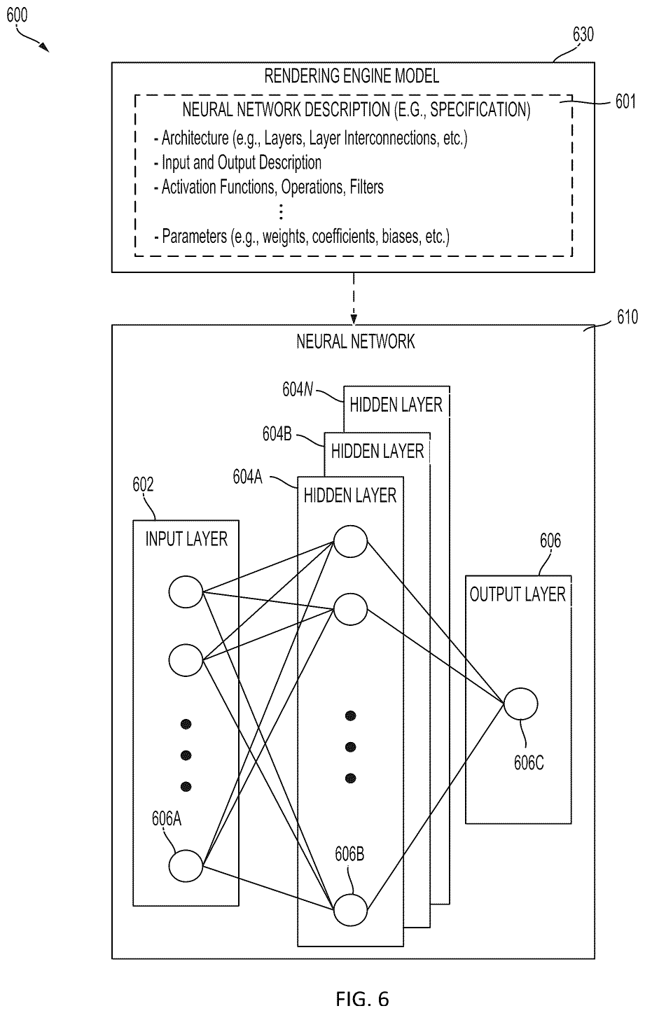

FIG. 6 illustrates an example neural network architecture. Architecture 600 includes a neural network 610 defined by an example neural network description 601 in rendering engine model (neural controller) 630. The neural network 610 can represent a neural network implementation of a rendering engine for rendering media data. The neural network description 601 can include a full specification of the neural network 610, including the neural network architecture 600. For example, the neural network description 601 can include a description or specification of the architecture 600 of the neural network 610 (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 610 reflects the architecture 600 defined in the neural network description 601. In this example, the neural network 610 includes an input layer 602, which includes input data, such as extracted coursework progression data. In one illustrative example, the input layer 602 can include data representing a portion of the input media data such as a patch of data or pixels (e.g., extracted coursework progression data).

The neural network 610 includes hidden layers 604A through 604 N (collectively “604” hereinafter). The hidden layers 604 can include n number of hidden layers, where n is an integer greater than or equal to one. The number of hidden layers can include as many layers as needed for a desired processing outcome and/or rendering intent. The neural network 610 further includes an output layer 606 that provides an output (e.g., predicted status) resulting from the processing performed by the hidden layers 604. In one illustrative example, the output layer 606 can predict statuses.

The neural network 610 in this example is a multi-layer neural network of interconnected nodes. Each node can represent a piece of information. Information associated with the nodes is shared among the different layers and each layer retains information as information is processed. In some cases, the neural network 610 can include a feed-forward neural network, in which case there are no feedback connections where outputs of the neural network are fed back into itself. In other cases, the neural network 610 can include a recurrent neural network, which can have loops that allow information to be carried across nodes while reading in input.

Information can be exchanged between nodes through node-to-node interconnections between the various layers. Nodes of the input layer 602 can activate a set of nodes in the first hidden layer 604A. For example, as shown, each of the input nodes of the input layer 602 is connected to each of the nodes of the first hidden layer 604A. The nodes of the hidden layer 604A can transform the information of each input node by applying activation functions to the information. The information derived from the transformation can then be passed to and can activate the nodes of the next hidden layer (e.g., 604B), which can perform their own designated functions. Example functions include convolutional, up-sampling, data transformation, pooling, and/or any other suitable functions. The output of the hidden layer (e.g., 604B) can then activate nodes of the next hidden layer (e.g., 604 N), and so on. The output of the last hidden layer can activate one or more nodes of the output layer 606, at which point an output is provided. In some cases, while nodes (e.g., nodes 608A, 608B, 608C) in the neural network 610 are shown as having multiple output lines, a node has a single output and all lines shown as being output from a node represent the same output value.

In some cases, each node or interconnection between nodes can have a weight that is a set of parameters derived from training the neural network 610. For example, an interconnection between nodes can represent a piece of information learned about the interconnected nodes. The interconnection can have a numeric weight that can be tuned (e.g., based on a training dataset), allowing the neural network 610 to be adaptive to inputs and able to learn as more data is processed.

The neural network 610 can be pre-trained to process the features from the data in the input layer 602 using the different hidden layers 604 in order to provide the output through the output layer 606. In an example in which the neural network 610 is used to predict statuses, the neural network 610 can be trained using training data that includes historical coursework progression data and historical statuses. For instance, extracted coursework progression data can be input into the neural network 610, which can be processed by the neural network 610 to generate outputs which can be used to tune one or more aspects of the neural network 610, such as weights, biases, etc.

In some cases, the neural network 610 can adjust weights of nodes using a training process called backpropagation. Backpropagation can include a forward pass, a loss function, a backward pass, and a weight update. The forward pass, loss function, backward pass, and parameter update is performed for one training iteration. The process can be repeated for a certain number of iterations for each set of training media data until the weights of the layers are accurately tuned.

For a first training iteration for the neural network 610, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, the neural network 610 is unable to determine low level features and thus cannot make an accurate determination of what the classification of the object might be. A loss function can be used to analyze errors in the output. Any suitable loss function definition can be used.

The loss (or error) can be high for the first training dataset (e.g., extracted coursework progression data) since the actual values will be different than the predicted output. The goal of training is to minimize the amount of loss so that the predicted output comports with a target or ideal output. The neural network 610 can perform a backward pass by determining which inputs (weights) most contributed to the loss of the neural network 610, and can adjust the weights so that the loss decreases and is eventually minimized.

A derivative of the loss with respect to the weights can be computed to determine the weights that contributed most to the loss of the neural network 610. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 610 can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 610 can represent any other neural or deep learning network, such as an autoencoder, a deep belief nets (DBNs), a recurrent neural networks (RNNs), etc.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A method of screening and scoring resumes, the method comprising;
extracting a first set of keywords from a text description;
defining one or more rules for machine-learning based on one or more patterns identified in the first set of keywords;
extracting a second set of keywords from a plurality of candidate resumes based on the defined machine-learning rule;
classifying at least a subset of the second set of keywords in a structured output that identifies named entities associated with a set of corresponding keywords;
scoring each named entity based on how closely the respective set of corresponding keywords matches the first set of keywords by using a scoring model; and
presenting the matching scores with the respective named entities.

2. The method of claim 1, wherein the scoring model scores each named entity by:
generating embeddings for each keyword of he first set of keywords and the respective corresponding keyword of the second set of keywords;
passing the embeddings for each keyword of the first set of keywords through a first transformer decoder and the respective corresponding keyword of the second set of keywords through a second transformer decoder;
concatenating outputs from the first transformer decoder and the second transformer decoder;
passing the concatenated outputs though a transformer encoder; and
sending transformer encoder outputs through a neural network feed-forward network to obtain respective matching scores.

3. The method of claim 1, wherein the scoring model further:
adds a special learnable token to the concatenated outputs; and
passes the concatenated outputs with the added special learnable token through the transformer encoder, wherein the transformer encoder outputs that correspond to the special learnable token are sent through the neural network feed-forward network.

4. The method of claim 1, wherein the machine-learning rule further assigns a score to each word based on how often each word appears and how rare it is across the plurality of candidate resumes using a term frequency inverse document frequency process.

5. The method of claim 1, wherein the transformer encoder further:
processes an input sequence of tokens through a stack of encoder layers with each layer consisting of a multi-head self-attention; and
determines a weighted sum of the input sequence based on similarities of the respective tokens.

6. The method of claim 1, wherein the neural network feed-forward network includes multiple layers of interconnected neurons organized into layers and with each layer connected to a respective next layer by a set of weighted connections computing a weighted sum of inputs from a previous layer and passing a respective result through a nonlinear activation function to produce the respective matching scores.

7. A non-transitory computer-readable storage medium comprising instructions executable by a computing system to perform a method of screening and scoring resumes, the method comprising:
extracting a first set of keywords from a text description;
defining one or more rules for machine-learning based on one or more patterns identified in the first set of keywords;
extracting a second set of keywords from a plurality of candidate resumes based on the defined machine-learning rule;
classifying at least a subset of the second set of keywords in a structured output that identifies named entities associated with a set of corresponding keywords;
scoring each named entity based on how closely the respective set of corresponding keywords matches the first set of keywords by using a scoring model; and
presenting the matching scores with the respective named entities.

8. The non-transitory computer readable medium of claim 7, wherein the scoring model scores each named entity by:
generating embeddings for each keyword of he first set of keywords and the respective corresponding keyword of the second set of keywords;
passing the embeddings for each keyword of the first set of keywords through a first transformer decoder and the respective corresponding keyword of the second set of keywords through a second transformer decoder;
concatenating outputs from the first transformer decoder and the second transformer decoder;
passing the concatenated outputs though a transformer encoder; and
sending transformer encoder outputs through a neural network feed-forward network to obtain respective matching scores.

9. The non-transitory computer readable medium of claim 7, wherein the scoring model further:
adds a special learnable token to the concatenated outputs; and
passes the concatenated outputs with the added special learnable token through the transformer encoder, wherein the transformer encoder outputs that correspond to the special learnable token are sent through the neural network feed-forward network.

10. The non-transitory computer readable medium of claim 7, wherein the machine-learning rule further assigns a score to each word based on how often each word appears and how rare it is across the plurality of candidate resumes using a term frequency inverse document frequency process.

11. The non-transitory computer readable medium of claim 7, wherein the transformer encoder further:
processes an input sequence of tokens through a stack of encoder layers with each layer consisting of a multi-head self-attention; and
determines a weighted sum of the input sequence based on similarities of the respective tokens.

12. The non-transitory computer readable medium of claim 7, wherein the neural network feed-forward network includes multiple layers of interconnected neurons organized into layers and with each layer connected to a respective next layer by a set of weighted connections computing a weighted sum of inputs from a previous layer and passing a respective result through a nonlinear activation function to produce the respective matching scores.

13. A system comprising:
one or more processors; and
a non-transitory computer-readable medium storing instructions that, when executed by the one or more processors, cause the one or more processors to:
extract a first set of keywords from a job description;
determine one or more patterns of words of the first set of keywords that define one or more rules of a machine-learning rule-based method;
extract, based on the machine-learning rule-based method, a second set of keywords from a plurality of candidate resumes;
classify at least a subset of the second set of keywords in a structured output that identifies named entities and their corresponding keywords;
score each named entity based on how closely they matched with the first set of keywords by using a scoring model; and
present the matching scores with the respective named entities.
